(19) United States
(12) Patent Application Publication
(10) Pub. No.: US 2011/0227709 A1
(43) Pub. Date: Sep. 22, 2011

(54) WIRELESS ASSET MANAGEMENT AND DEMAND FLOOR PLAN AUDIT SYSTEM

(76) Inventor: Brian Story, Victorville, CA (US)

(21) Appl. No.: 12/726,333

(22) Filed: Mar. 17, 2010

Related U.S. Application Data
(63) Continuation-in-part of application No. 12/077,832, filed on Mar. 20, 2008.
(60) Provisional application No. 60/919,324, filed on Mar. 20, 2007.

(51) Int. Cl. H04Q 5/22

(52) U.S. Cl. 340/10.42

(57) ABSTRACT

Disclosed is a vehicle tracking and system for a vehicle dealerships, storage facilities and financial institutions. The vehicle tracking system includes wireless security apparatus that is coupled with a vehicles OBD-II system. The wireless security apparatus communicates with one or more GPS satellites to obtain location and other GPS generated data. The wireless security apparatus communications using radio-frequency signals and the internet to transfer the GPS data and vehicle OBD-II data to a service facility.

### CROSS-REFERENCES

The present application is a continuation-in-part of patent application Ser. No. 12/077,832 filed on Mar. 20, 2008 which claims priority to Provisional Application 60/919,324 filed on Mar. 20, 2007 both entitled “Wireless Security and Asset Management Control System” currently pending and also claims priority to Provisional Application 61/160,764 filed on Mar. 17, 2009 entitled “On Demand Floor Plan Audit System” and Non-Provisional application Ser. No. 12/717,877 filed on Mar. 4, 2010 and entitled “Remote Telemetric Panic and Service Apparatus”. These applications are incorporated herein by this reference.

### FIELD OF THE INVENTION

This present invention is generally related to vehicle inventory and security systems. More specifically, the present invention is a system consists of a wireless security system which are installed into each vehicle to be tracked and inventoried, and a tracking system which allows users to analyze available data and monitor the use of the system.

### BACKGROUND OF THE INVENTION

Vehicle security is not only a primary concern for consumers, but also for auto dealers concerned with the potential theft of their vehicle inventory. Manufacturers have addressed consumer concerns by building vehicles with sophisticated security systems that can include any combination of motion sensors, vibration sensors, transponder key systems, or ignition deactivation systems. Aftermarket security systems are also available to consumers through auto dealers, and may add security to an unprotected vehicle or supplement an already existing factory installed security system.

Many aftermarket security systems require a direct electrical connection to the vehicle's existing wiring system and may utilize a blinking L.E.D. indicating the presence of a security system. Such a blinking L.E.D. only serves the purpose of alerting a thief of the system's presence, thus enabling a thief to quickly and easily disable such aftermarket security systems by cutting the associated wiring harness. Other aftermarket security systems rely on in-dash receivers that communicate with a remote transmitter or transponder which can recognize a code programmed into the receiver. These aftermarket systems may also be easily circumvented by a thief using a signal scanner to decode the programmed signal.

An alternative to the aforementioned hard wire or in-dash system is the easily installed (or removed) wireless “intelligent” relay-based security system, which utilize advanced microelectronics to disable the vehicle's engine. The intelligent relay replaces a factory relay in the power distribution box under the hood or in the kick panel inside the vehicle. No L.E.D. betrays its presence, and without a wiring harness, thieves cannot disconnect or hotwire the system. Activation requires the use of a radio frequency decoded remote key fob. Sophisticated microelectronics utilize rolling code technology to eliminate code grabbing or scanning. Each 5 relay stores a different code and only the remote programmed to the relay will recognize the code or allow the vehicle to start. Instead of installing a wireless “intelligent” relay-based security system, the dealer could alternatively install a wireless module which connects to the onboard computer of the vehicle, either through the OBDII port (On board Diaognostic Port) or connected directly to the vehicles' onboard computer wiring harnesses. In this way, the security system enables or disables the starting function of the vehicle by communicating with the vehicle's onboard computer rather than replacing the vehicle's starter relay. By linking the remote control functionality with the vehicle's computer, additional functions other than vehicle security could be enabled from the user's remote key fob, i.e., the vehicle could be started remotely, windows rolled down, air conditioning turned on, etc. Most dealers choose to pre-install these consumer-focused security systems on their inventory of vehicles. In this way, the security system can be demonstrated to the customer by the sales person at the same time he is demonstrating the features of the vehicle to be sold. This system can be sold and installed through other channels such as Retail Automotive Stores, internet, direct marketing, etc. The sales person can include the system in the price of the vehicle and reaffirm the features and benefits to the customer. If the customer declines to purchase the preinstalled security system, the security system is often not removed from the vehicle, rather the system is simply not activated and remains on the vehicle after the customer takes delivery. The dealer absorbs the loss of the security system plus the labor to install it as part of the “drive away” cost of pre-installing the security systems on his vehicle inventory. Unfortunately, the consumer-focused security systems described above do not addresses the specific needs of an auto dealer. Unlike consumers, auto dealers may have hundreds of vehicles to secure. An auto dealer's primary objective is to sell as many of these vehicles as fast as possible. In order to do this, the auto dealer hires numerous sales people to demonstrate the features of each vehicle to potential buyers. One of the key feature of such demonstrations is the “test drive.” Typically consumer-focused security systems are designed for only one or two authorized drivers. An auto dealer, however, has a need to give every sales person the ability to drive each of the hundreds of vehicles in the dealer's inventory. As a result of using standard consumer-focused security systems, the auto dealer must maintain a different remote for each vehicle in inventory. The tracking and management of such remotes is not efficient or cost-effective for the auto dealer. It also creates hassles for sales people who want to respond quickly to potential buyers. There is therefore a need for a security system that secures an auto dealers vehicle inventory, yet also addresses the unique business environment in which an auto dealership exists. It is this and other needs to which the present invention is directed.

### SUMMARY OF THE INVENTION

The present application discloses a system for tracking and securing the vehicle inventory of a vehicle dealership or storage facility. In the preferred embodiment, the system consists of a wireless security system which are installed into each vehicle to be tracked and inventoried, and a tracking system which allows users to analyze available data and monitor the use of the system.

### BRIEF DESCRIPTION OF THE DRAWINGS

FIG. 1 is a perspective and partial sectional view of monitored vehicle with the wireless security system installed in the vehicle.

FIG. 2 is a perspective view of wireless security apparatus and the On Board Diagnostic (OBD-II) coupler.

FIG. 3 is a perspective view of a series of monitored vehicles parked on a lot and showing the wireless navigation and data communication means using a cellular carrier and eventually to a service facility.

FIG. 4 is an example report that is generated from the wireless security apparatus installed in a monitored vehicle displayed on the computer screen or a report that was generated from the database.

FIG. 5 is a flowchart for the order process and registration of the present invention method.

FIG. 6 is a flowchart of the wireless communication process of the present invention method.

### DESCRIPTION OF THE PREFERRED EMBODIMENTS

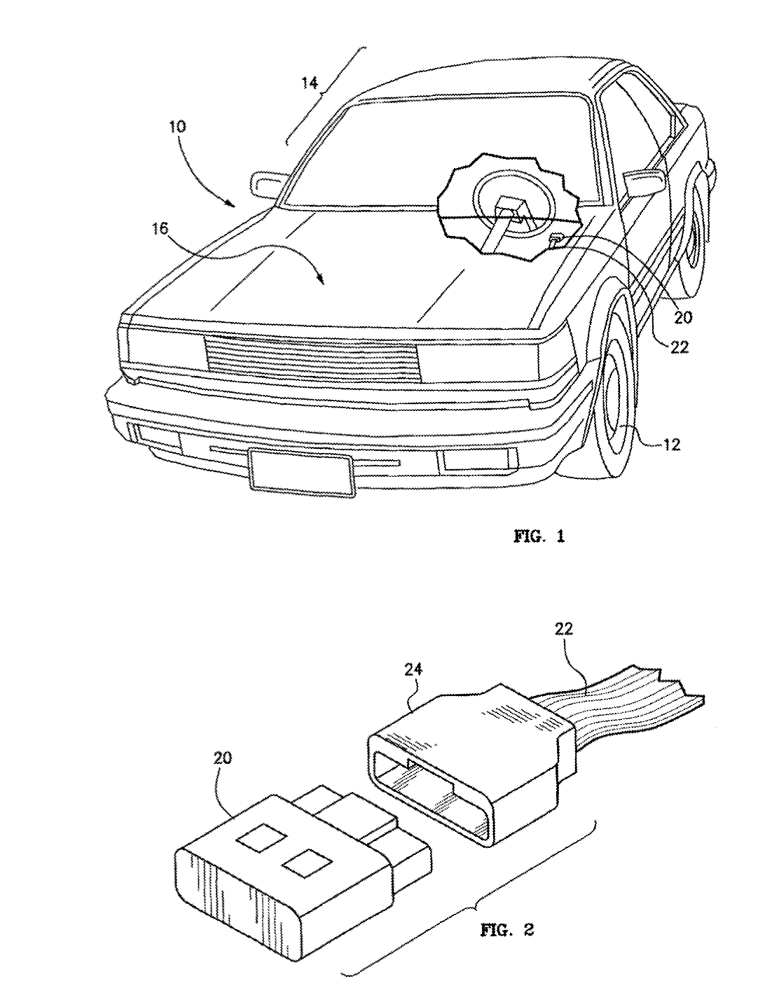

Referring to FIG. 1, shown therein is a perspective and partial sectional view of monitored vehicle with the wireless security apparatus 20 installed in the vehicle 10. Also shown is the wireless security apparatus 20 connected to the On Board Diagnostic coupler 24 (OBD-II). In addition, this figure shows the vehicle with a particular model 14, with a set of particular wheels 12 and with a particular color 16. As every car can identified individually using the Vehicle Identification Number (VIN), even if two or more cars have the same body style, color, and wheels types, they could be identified individually using the VIN.

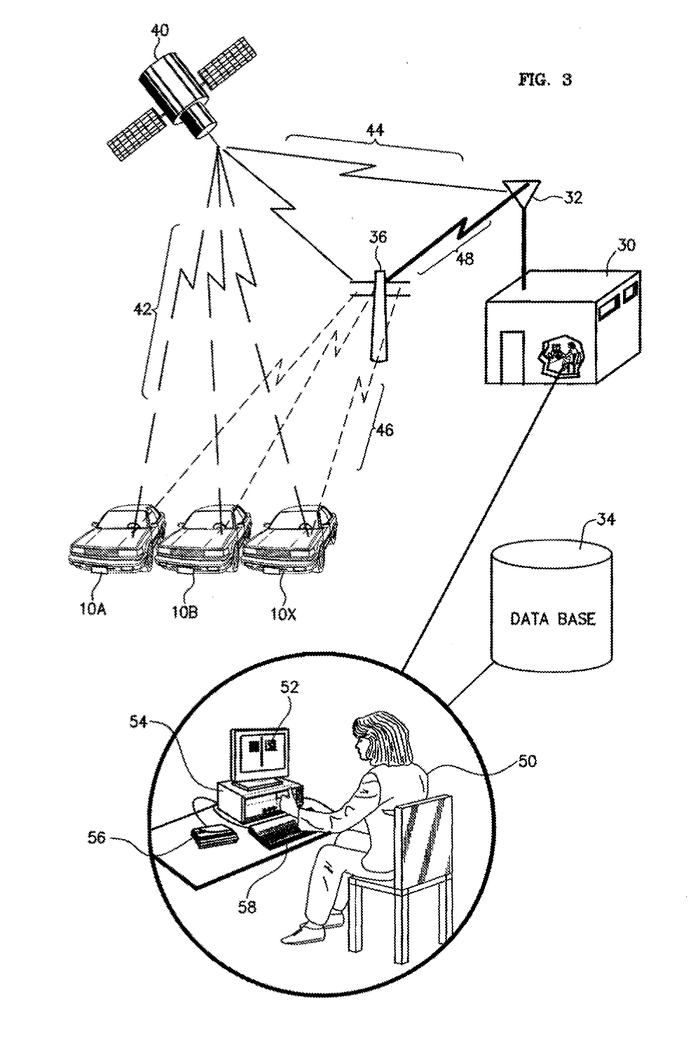

FIG. 2 is a perspective view of wireless security apparatus 20 and the On Board Diagnostic (OBD-II) coupler 22.

All cars and trucks built and sold in the United States after Jan. 1, 1996 were required to be OBD-II equipped. Generally the OBD-II has 16 pins with pin 2 connected to the J1850 Bus, Pin 4 connected to the chassis ground, Pin 5 signal ground, Pin 6 connected to CAN High (J-2284), Pin 7 connected to ISO 9194-2K line, Pin 10 connected to the J1850 bus, Pin 15 connected to CAN low (J2284), and Pin 16 connected to the battery power. Important to the wireless security apparatus 20 and the present invention method is its ability to wirelessly obtain the vehicle identification number (VIN) when connected to the OBD-II coupler. Generally, GM cars and trucks use the SAE J1850 VPW (variable pulse width modulation), Ford cars and trucks the SAE J1850 PPW (pulse width modulation), and Chrysler, all European and most Asian imports us the ISO 9141 circuitry. This is the pin or port that the present invention method will obtain the vehicle identification number (VIN) for individual vehicle tracking and monitoring. Generally the coupler 22 is made of a plastic material and has metallic pins for electrical connections.

The wireless security apparatus 20 contains electrical circuitry that includes, but is not limited to, a microprocessor, OBD-II reader, a radio-frequency data transmitter, GPS receiver, and various internal antennas for communicating with the GPS satellites and the radio-frequency communication means that is housed in a polymer or metallic case and has a female receptacle designed to mount with the male receptacle of the OBD-II coupler. The wireless security apparatus 20 gets its electrical power from the OBD-II coupler 22. Once installed and initialized, the wireless security apparatus 20 can begin transferring data to a service facility 30. Besides being able to transfer data, the present invention method can detect if the wireless security apparatus 20 has been removed or transferred to another vehicle. It is anticipated by the Applicant that the wireless security apparatus 22 could have its own power source (e.g. battery) if it is necessary to monitor a vehicle has a battery disconnected, running low on power, or continue to communicate wirelessly if disconnected from the OBD-II.

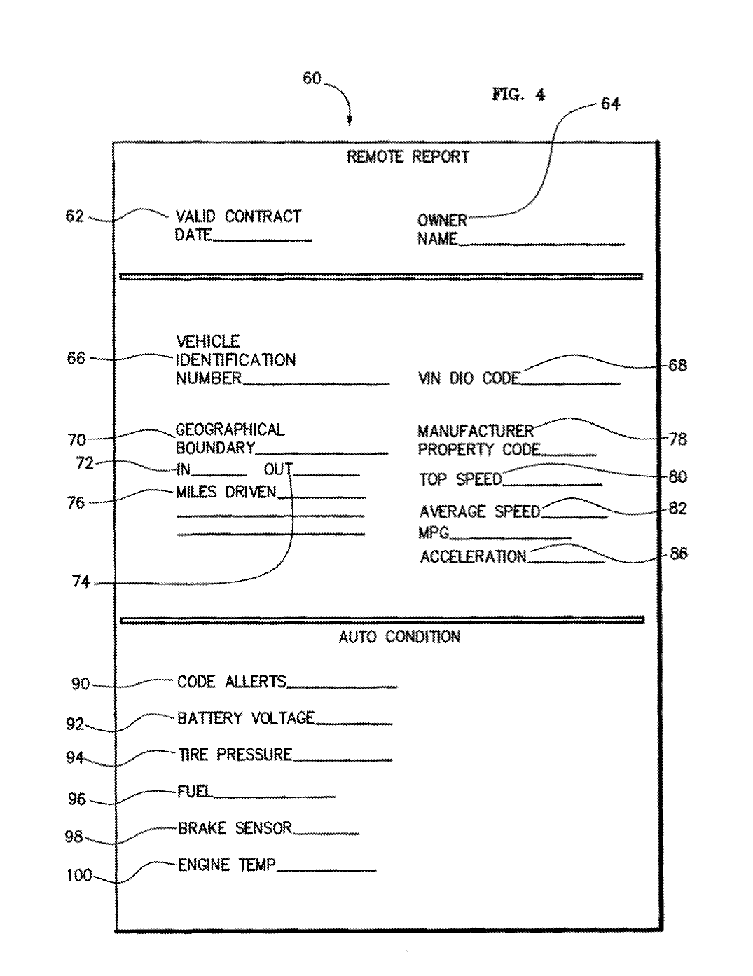

FIG. 3 is a perspective view of a series of monitored vehicles 10a, 10b and 10x parked on a lot and showing the wireless navigation means 42 and data communication means 46, 48 using a cellular carrier and eventually to a service facility 30 antenna 32. The wireless security apparatus installed in the vehicle periodically receives a navigations signal 42 from one or more GPS satellites 40. The wireless security apparatus 20 then periodically sends a wireless data signal 46, 48 using a cellular carrier, (e.g. ATT, Verizon, Sprint) which eventually can be received by the antenna 32 of the service facility. AS shown in the Figure, the wireless data signal 46, 48 can travel over one or more cellular towers 36 to eventually be received by the service facility 30. Also as shown in the Figure, the service facility 30 can receive navigation data 44 directly from the satellites to monitor GPS signal strength or non-operation.

The wireless data signal 46, 48 can include data such as the navigation position of the vehicle, VIN, miles driven, dates and times that vehicle was moved, top speed, average speed, miles per gallon, acceleration, code alerts, battery voltage, fuel level, brake sensor and engine parameters. Other parameters may be available to be collected by the wireless security apparatus 20 and transferred wirelessly for data collection.

Within the service facility 30 are one or more operators 50 who will utilize a computer system to collect and process the navigation and data signals received. The computer system can be programmed to send a signal back to the wireless security apparatus 20 to initiate any periodic monitoring, e.g. each day at 7:00 p.m. As shown for representative purpose, the figure shows the operator 50 using a computer with a display 52, keyboard 58 and a communication means 56. It is anticipated by the Applicant that any computer style or type, (Mac, no keyboard) can be employed by the present invention method. It is also anticipated by the Applicant that an operator 50 may not be necessary as the computer can be programmed to perform all the operations automatically. Also shown is a data base that will used to collect, organize and prepare reports from on periodic VIN, navigation and vehicle parameter data collected. The database can serve various functions, such as preparing reports or data tables in various formats to financing institutions (e.g. location and audit functions) and car dealerships (e.g. times car has been road demonstrated over a given period, ranking of popular cars and trucks).

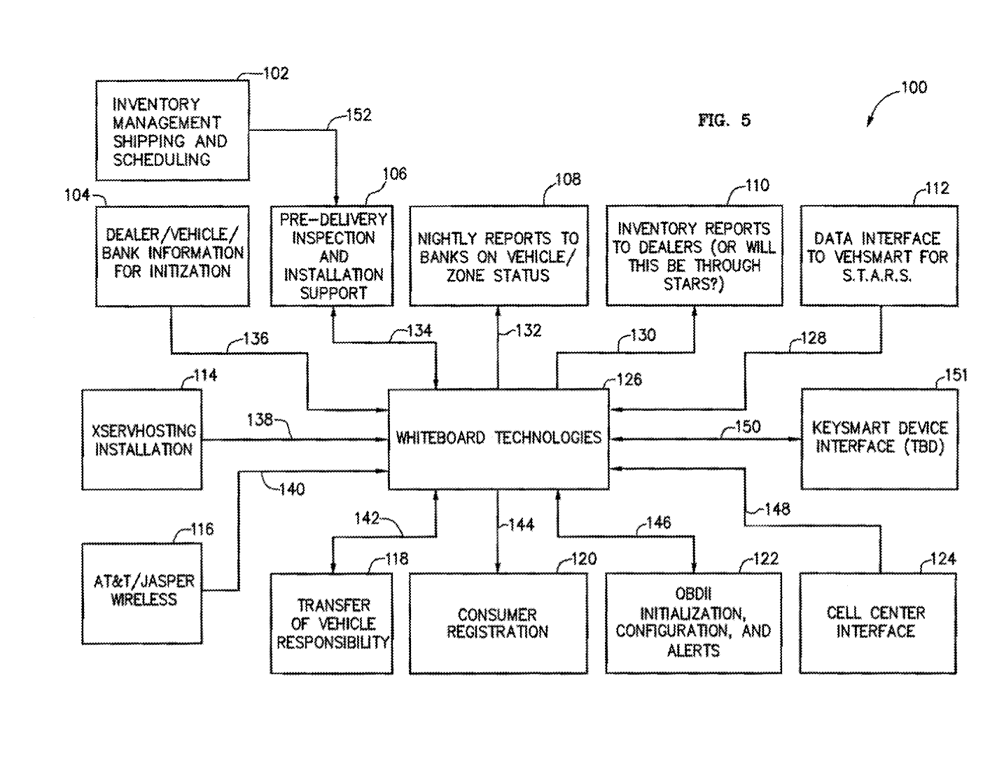

FIG. 4 is an example report 60 that is generated from the wireless security apparatus 20 installed in a monitored vehicle 10 displayed on the computer screen 52 or a report that was generated from the database 34. This exemplary report shows in the top box, the valid date of the contract 62 between a client and the service provider and the owner of the vehicle's name 64. Provide below the first box is a second box have including the vehicle identification number 66, VIN DIO code 68, the geographic boundary 70, dates in 72 and out 74, miles driven 76, the manufacturer property code 78, and the top speed 80, average speed 82, miles per gallon 84 and acceleration 86 obtained during road demonstrations (over a given period).

In the bottom box, data concerning the auto condition is provide, such as code alerts 90, battery voltage 92, tire pressure 94, fuel 96, brake sensor 98 and engine temperature 100.

This only an example of a report and many other report types and designs can be generated, processed or organized.

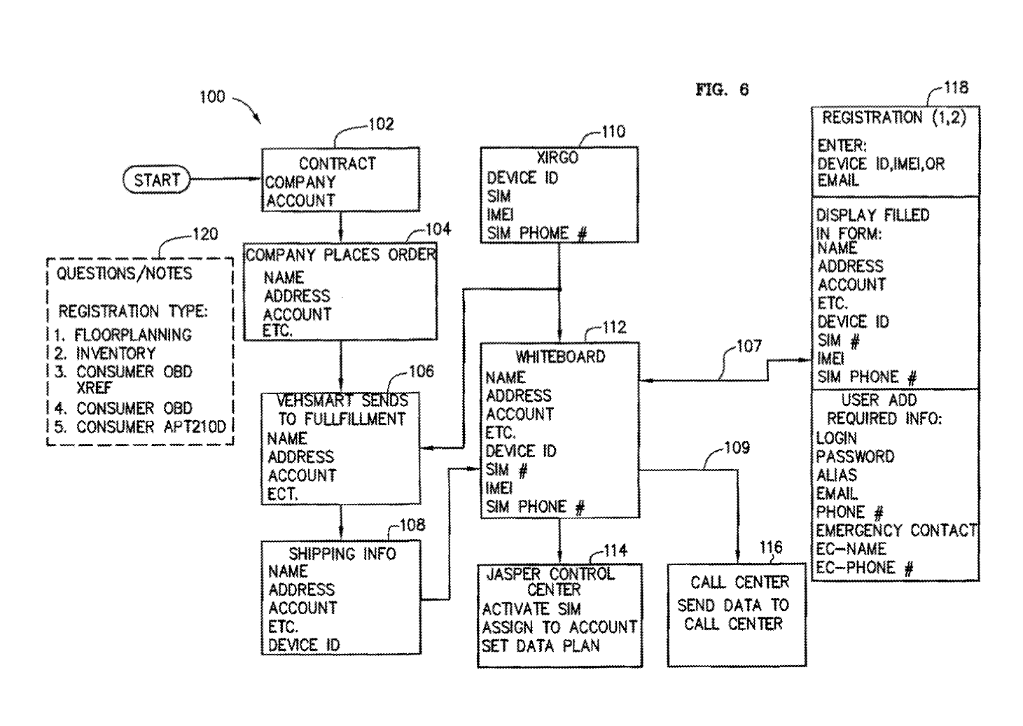

Now referring to FIG. 5. which presents a flowchart for the order process and registration 100 of the present invention method. The ordering process is started by completing a contact information 102 and then completing the information concerning the company (or consumer) placing an order 104. Box 102 is shown recording the company name and the account number. Box 104 shows recording the company name, address, and account number. VehSmart processes the order and then sends a confirmation 106 to the company (or consumer) placing the order. Box 106 shows recording the company name, address, and account number. In this step, VehSmart will ship 108 one or more wireless security apparatuses 20 using the name, address, account of the company (or consumer). Box 108 records the company name, address, account and specific identified wireless security apparatuses 20. Each wireless security apparatus 20 will have a specific device ID. The shipping information with wireless security apparatus identification number is sent 105 to the service facility 30. Subsequently, the specifically ID wireless security apparatus 20 will have to specifically associated with a vehicle and this information will be sent by the company (or consumer) and recorded in the client's account. In box 110, an example contract manufacturer of the wireless security apparatus is Xirgo Technologies, located in Camarillo, Calif. The specific identified wireless security apparatuses 20 will be shipped from the contract manufacturer to the VehSmart inventory 103. Alternately, the specific identified wireless security apparatus 20 could be drop shipped from the contract manufacturer with an appropriate transfer of data to VehSmart. A contract service facility 30 is shown in box 112 which records the various ordering data into a data base, records the navigation data and data parameters sent by the plurality of installed wireless security apparatus 20, maintains the data base, and is responsible for generating reports for various dealerships, storage facilities and financial institutions. When an alert or mapping position, the contact service facility 30 can send a request and the appropriate data 109 to a call center (Box 116). Box 114 represents the wireless cellular companies that are contracted to provide a radio-frequency data link for transferring the navigation and vehicle parameter data from the monitored vehicles to the contract service facility. Box 118 shows an example of the service facility data base filed that will be maintained for each company or consumer. It includes the registration information and other contact, and login specification. Box 120 shows the recording of registration types, floor plan auditing, inventory, and consumer OBD-II.

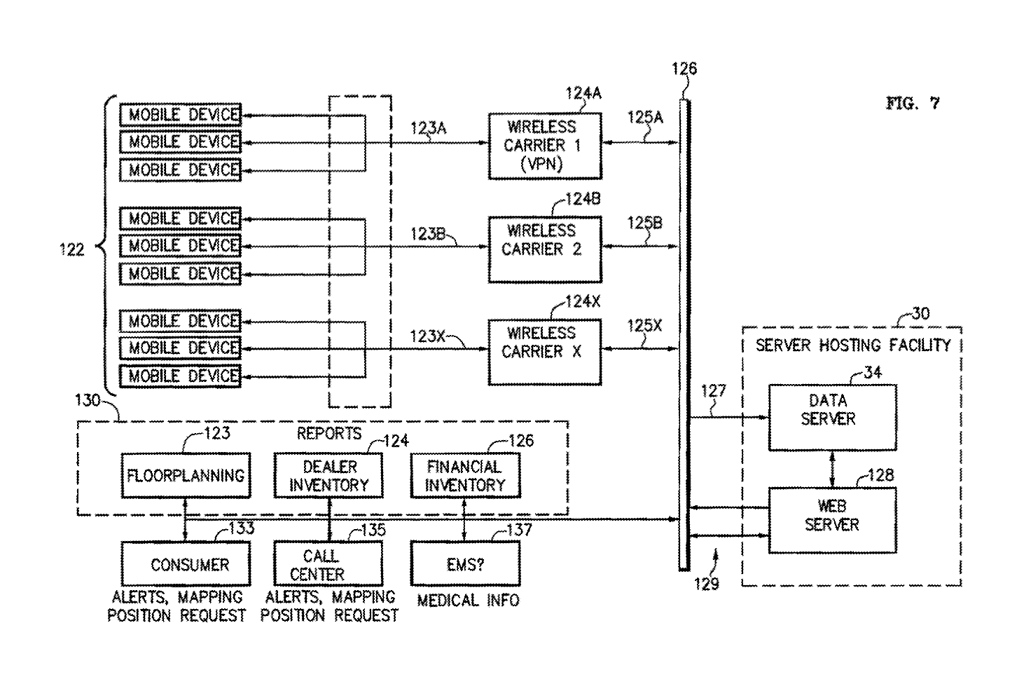

FIG. 6 is a flowchart of the wireless communication process of the present invention method. The plurality of mobile devices 122 represents a series of monitored vehicles. The navigation data and the vehicle parameter data is periodically transmitted using radio-frequency signals 123a, 123b and 123x using cellular wireless carriers (e.g. ATT, Verizon, Sprint) 124a, 124b, and 124x and their technology/equipment. The wireless navigation data and vehicle data parameters will be transferred 125a, 125b and 125x to the internet 126. From the internet 126, the service facility 30 will receive the internet transferred data 127 for downloading, processing and recording functions. The service facility includes a web server 128 that can generate reports 130 over the internet. The reports can be generated for floor plan auditing 132, a consumer 133, dealer inventory 134, financial institutions 136, the call center 135 or emergency medical service 137.

It is claimed:

1. A vehicle tracking and data system for a vehicle dealership, storage facility or financial institutions, which comprises the method:
Installing a specifically identified wireless security apparatus in specifically identified vehicle using the OBD-II receptacle, resulting in a monitored vehicle;
Periodically querying or interrogating wirelessly data parameters from the monitored vehicle, and
Said specifically identified wireless security apparatus transfer the data parameters wirelessly using radio-frequency signals and the internet to arrive at service facility;

2. A vehicle tracking and data system for a vehicle dealership, storage facility or financial institution as recite in claim 1,
whereby one of the data parameters includes the vehicle identification number (VIN).

3. A vehicle tracking and data system for a vehicle dealership, storage facility or financial institution as recite in claim 1,
whereby said transfer of data parameter using radio-frequency signals includes, in part, a cellular carrier wireless system.

4. A vehicle tracking and data system for a vehicle dealership, storage facility or financial institution as recite in claim 2,
whereby the vehicle identification number is receive from the OBD-II system of the vehicle.

5. A vehicle tracking and data system for a vehicle dealership, storage facility or financial institution as recite in claim 4,
whereby the vehicle identification number is transferred over the SAE J1850 VPW, SAE J1850 PPW or the ISO 9141 port.

6. A vehicle tracking and data system for a vehicle dealership, storage facility or financial institution as recite in claim 1,
whereby said data parameters include the vehicle's condition.

7. A vehicle tracking and data system for a vehicle dealership, storage facility or financial institution as recite in claim 1,
whereby said data parameters include the vehicle's use for actual road demonstrations.

8. A vehicle tracking and data system for a vehicle dealership, storage facility or financial institution as recite in claim 1, further comprising the method of said wireless security apparatus wirelessly communicating with one or more GPS satellites resulting in GPS location data.

9. A vehicle tracking and data system for a vehicle dealership, storage facility or financial institution as recite in claim 8, whereby location data can be determined on a specific frequency and period.

10. A vehicle tracking and data system for a vehicle dealership, storage facility or financial institution as recite in claim 8,
whereby said GPS location data is part of the data parameters.
